(19) United States
(12) Patent Application Publication
(10) Pub. No.: US 2005/0072046 A1
(43) Pub. Date: Apr. 7, 2005

(54) Biodegradable mulching-mat for preventing weeds and method for manufacturing the mat

(76) Inventors: Woon-Ho Yang, Kyunggi-do (KR); Je-Kyu Kim, Kyunggi-do (KR); Hee-Suk Han, Kyunggi-do (KR); Jae-Hyun Kim, Kyunggi-do (KR); Yang-Soon Kang, Kyunggi-do (KR); Jeong-Ju Shin, Kyunggi-do (KR); Sang-Joon Kim, Kyunggi-do (KR); Min-Hyuk Lee, Kyunggi-do (KR); Soon-Jong Han, Seoul (KR)

Correspondence Address: NIXON & VANDERHYE, PC, 1100 N GLEBE ROAD, 8TH FLOOR, ARLINGTON, VA, 22201-4714, US

(21) Appl. No.: 10/468,078

(22) PCT Filed: Apr. 9, 2002
(86) PCT No.: PCT/KR02/00631

(30) Foreign Application Priority Data
Apr. 13, 2001 (KR) 2001/19962

(51) Int. Cl. A01G 7/00; A01C 1/04

(52) U.S. Cl. 47/56; 47/9

(57) ABSTRACT

There are provided a biodegradable mulching-mat for preventing weed in rice cultivation having improved biodegradability to be completely degraded in several months, good mulching properties of preventing the growth of weeds, elevating soil temperature and increasing soil moisture capacity, and good strength and durability; and a method for manufacturing said mulching-mat by means of extrusion molding.

### BACKGROUND OF THE INVENTION

1. Field of the Invention

The present invention relates to a biodegradable mulching-mat for rice cultivation and to a method for manufacturing the mat. More specifically, the present invention relates to a biodegradable mulching-mat for preventing the appearance and growth of the weed in rice cropping, that having laminated structure of paper and biodegradable resin. The present mulching-mat can effectively inhibit the appearance of weeds without herbicide and can be completely degraded in the paddy soil in a few months.

2. Description of the Related Arts

Generally, mulching-mats can be classified into mulching-films for weed control in upland cropping and into sheets for raising seedlings or seeding.

With regard to mulching-films, Korean Pat. Appln. No. 1999-3319 discloses a mulching-film comprising polyethylene as a main material. The polyethylene film is mainly used in upland cropping and exhibits high transmittance, soil temperature-elevating effect, weed-controlling effect and good strength and durability. Moreover, it contains ultraviolet-scattering agent and red-wavelength light-supplying agent to decrease damages by harmful insects. But, the film is non-biodegradable in the soil, and that resulting in bad affection on the soil and water environment. Thereby, after harvest it must be physically removed from the field.

A mulching-film having photo- and biodegradability is disclosed in Korean Pat. Appln. No. 1996-64953. The above film comprises non-degradable polyethylene and biodegradable aliphatic polymers and exhibits as good properties as polyethylene film and further exhibits enhanced biodegradability. But, in the one-year-unit agriculture system, non-degradable polyethylene component remains in the soil. Therefore, there has been need for substitutional materials with complete degradability that can replace the polyethylene.

Further, as to sheets for raising seedling or seeding, non-woven fabric sheet has been extensively used. The non-woven sheet made by mixing cellulose fiber and biodegradable polyester fiber and subjected to heat adhesion treatment is well-known. After punching the non-woven and recycled paper sheet, biodegradable non-woven with seed is attached therebetween. The sheet exhibits good mulching properties. But, because the sheet has poor adsorption to the soil and problem in punching, it cannot be used in both machine transplanting and direct sowing. Therefore, there has been need for substitutional sheets applied extensively to machine transplanting and direct sowing.

Accordingly, in order to solve the conventional problems and to improve biodegradability of the mulching-mat adapted to both machine transplanting and direct sowing, the present inventors have researched repeatedly, to find that laminated sheet obtained by coating paper with biodegradable resin film containing thermoplastic aliphatic polyester exhibits good mulching properties by elevating soil temperature and preventing weeds, with good strength as non-degradable polyethylene film and can be completely degraded in the soil after harvest. Further, we found that the present mat could be adapted to both machine transplanting and direct sowing.

### SUMMARY OF THE INVENTION

Therefore, one object of the present invention is to provide a mulching-mat for preventing weed in rice cropping having improved biodegradability, good mulching properties in weed-preventing effect and soil temperature-elevating effect, and good strength and durability.

Another object of the present invention is to provide a biodegradable mulching-mat to be adapted to both machine transplanting and direct sowing.

A further object of the present invention is to provide a method for manufacturing said mulching-mat.

In order to achieve said objects, the present invention provides a mulching-mat having a laminated structure obtained by coating a paper sheet with biodegradable resin film containing completely-biodegradable thermoplastic aliphatic polyester.

Further, the present invention provides a method for manufacturing said mat comprising steps of;
(1) melt-coating the paper with biodegradable resin film by means of extrusion molding; and
(2) scrolling the coated paper obtained in step (1).

These and other objects and advantages of the invention will become apparent to those ordinary skilled in the art from the following detailed description as considered in conjunction with the accompanying drawings.

### BRIEF DESCRIPTION OF THE DRAWINGS

FIG. 1 shows a mulching-mat according to the present invention, which has a laminated structure of paper and biodegradable film coated thereon with a plurality of perforations for seeding.

FIG. 2 are photographs showing aspects of seedling stand and weed growth;

FIG. 2a shows weed proliferation in non-mulched cultivation;

FIG. 2b shows the rice cultivation using the mulching-mat of Comparative Example 1 composed of the resin film alone without paper sheet, after one (1) month of seeding; and

FIG. 2c shows the rice cultivation using the mulching-mat of Example 1 composed of a paper sheet and resin film coated thereon, after one (1) month of seeding.

### DETAILED DESCRIPTION OF THE INVENTION

The following is a detailed description of the present invention.

The present invention is based on the findings that laminated sheet obtained by melt coating a paper sheet with biodegradable resin film containing thermoplastic aliphatic polyester by means of extrusion molding can exhibit improved biodegradability and be adapted to both machine transplanting and direct sowing. Accordingly, the present mulching-mat can be advantageously used in one-year-unit rice cultivation which has either form of machine transplanting or of direct sowing, and can be completely degraded in the soil after harvest.

Further, the present mulching-mat has good adsorption to the soil so as to exhibit good mulching properties by elevating soil temperature, controlling the weeds and increasing soil moisture capacity.

The following is a detailed description of the best mode of the present invention.

The present invention overcame the fault of paper sheet or non-woven that are easily wet and torn, and the fault of the polyethylene film that are not degradable and easily torn.

According to the present invention, the biodegradable resin film may be composed of thermoplastic aliphatic polyester represented by the following
Formula 1 or Formula 2: 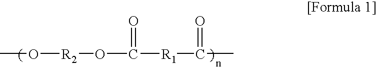
(wherein, n is an integer and represents repeating unit; R₁ represents an aliphatic hydrocarbon having a carbon number of 2˜6; and R₂ represents an aliphatic hydrocarbon having a carbon number of 2˜8) 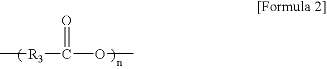
(wherein, n is an integer and represents repeating unit; and R₃ represents an aliphatic hydrocarbon having a carbon number of 2˜6).

Aliphatic polyester of the Formula 1 may be prepared by condensation polymerization of aliphatic diol and aliphatic dicarboxylic acid. Said diol may be, but not limited thereto, ethylene glycol; propylene glycol; 1,4-butanediol; 1,6-hexanediol; and cyclohexane dimethanol. Said dicarboxylic acid may be, but not limited thereto, succinic acid and adipic acid.

Further, aliphatic polyester of the Formula 2 may be prepared by ring-opening polymerization of caprolacton, lactide or glycolide.

Though the above biodegradable resins represented by the Formula 1 and 2 have different process properties, they have similar decomposition phase. Accordingly, both can be advantageously applied to the present invention.

Further, said biodegradable resin film may further comprise natural or artificial resin such as starch, cellulose, polylactic acid or its copolymer, polycaprolactone and aliphatic polyester. These biodegradable resins that are further contained to the resin film have different process properties and decomposition phase, but they have affinities for environment and can be self-degraded in the soil after harvest, so they can be advantageously applied for rice cultivation.

And, the present resin film may further contain organic and/or inorganic additives, for example, bulking agent. Preferably, the resin film may contain one or more bulking agent selected from a group consisting of calcium carbonate, talc and starch. They can control degradation degree of the biodegradable resin in the soil, to be advantageously contained to the present resin film.

Finally, as a paper sheet to compose the present mulching-mat, it is prefer to use recycled paper in economic aspect, but it is not limited to a specific kind.

The present mulching-mat may have two laminated layers of the paper sheet and the biodegradable film, but have several layers by laminating the paper sheet and the biodegradable film.

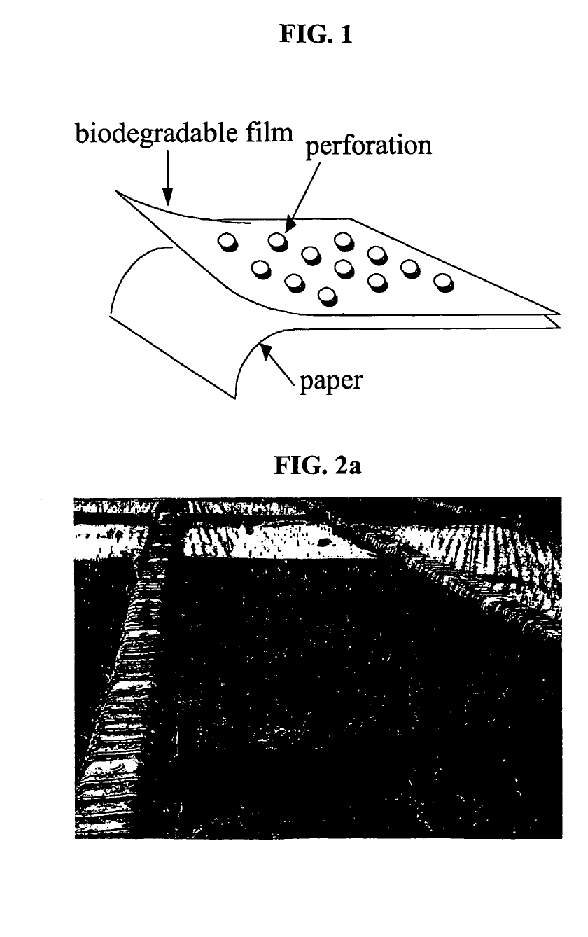

FIG. 1 shows a mulching-mat according to the present invention, which has a laminated structure of paper and biodegradable film coated thereon with a plurality of perforations for seeding. The perforations for seeding may be prepared in process of manufacturing the mat or just before seeding.

The present mulching-mat may be prepared by melt coating method that molding (extrusion molding) biodegradable thermoplastic resin on a paper sheet. This process is very important in the present invention.

Preferably, extrusion molding for melt coating starts from dried pellets of biodegradable resin alone or of admixture containing organic and/or inorganic additives. The pellets are transferred to a hopper from a hopper loader and introduced into an extruder to be melt. Finally, it is extruded at a sheet die and coated on a recycled paper supplied in a form of rolled flat. This coating process is named as “melt coating”. Thickness of the film obtained by melt coating may be determined by extruding amount and scrolling speed. It is necessary to determine degradation of biodegradable resin according to the rice cultivation condition. That is, excessive thickness may cause economical loss and take long time for degradation, and insufficient thickness may cause poor weed control. Therefore, the thickness of the resin film (coating thickness) may be preferably in the range of 5˜40 μm.

### PREFERRED EMBODIMENTS OF THE INVENTION

The present invention will be described in more detail by way of the following Examples, which should not be considered to limit the scope of the present invention.

### EXAMPLE 1

Recycled paper having thickness of 55 μm and weight of 45 gr/m² (made in Hansol Paper) was used. And, as a biodegradable resin, transparent polybutylene succinate of Formula 1 having a number average molecular weight of 40,000˜50,000, melting point of 114° C. and melt flow index of 20 (SG1111® manufactured in SK Chemicals) (hereinafter referred to as PBS) was used.

Pellets of the biodegradable resin were introduced into an extruder to be melt and extruded at a sheet die to be coated on the recycled paper supplied in a form of rolled flat. This melt coating process produced transparent two-layer mulching-mat having width of 900 mm and total thickness of 65 μm (paper thickness+coating thickness).

The mat was punched at a spacing of 30 cm horizontally and of 14 cm vertically and rice seeds (Ansanbyeo: testing varieties) were spot sowed in an amount of 30 kg per ha.

### EXAMPLE 2

The same procedure as Example 1 was performed excepting the thickness of the resin film. The coating thickness was controlled to produce the mat having total thickness of 67 μm.

### EXAMPLE 3

The same procedure as Example 1 was performed excepting the thickness of the resin film. The coating thickness was controlled to produce the mat having total thickness of 69 μm.

### EXAMPLE 4

The same procedure as that of Example 1 was performed except that a biodegradable resin containing 70 wt % of translucent polybutylene adipate of Formula 1 having a number average molecular weight of 40,000˜50,000 and melt flow index of 30 and 30 wt % of calcium carbonate (hereinafter referred to as PBA/Ca) were employed. The coating thickness was controlled to produce the mat having total thickness of 65 μm.

### EXAMPLE 5

The same procedure as that of Example 1 was performed except that a biodegradable resin containing transparent polycaprolactone of Formula 2 having melt flow index of 1˜2 (hereinafter referred to as PCL) was employed. The coating thickness was controlled to produce the mat having total thickness of 65 μm.

### COMPARATIVE EXAMPLE 1

The procedure of Example 1 was followed by employing the mulching-mat (15 μm) composed of the biodegradable resin PBS alone without paper sheet.

### COMPARATIVE EXAMPLE 2

The procedure of Example 1 was followed by employing the mulching-mat (25 μm) composed of the biodegradable resin PBS alone without paper sheet.

### COMPARATIVE EXAMPLE 3

The procedure of Example 1 was followed by employing the recycled paper of Example 1 alone as a mulching-mat without coating film.

### EXPERIMENTAL EXAMPLE 1

### Weed Prevention (Preventing the Growth of Weeds)

Weed control was evaluated by comparing dried weight of the weeds in non-mulched cultivation and in mulched cultivation, and calculated by the following formula:
Weed prevention value={1−(dried weight of the weeds in mulched cultivation/dried weight of the weeds in non-mulched cultivation)}×100

The results are shown in Table 1.

### EXPERIMENTAL EXAMPLE 2

### Biodegradability of the Mat

Biodegradability of the mat was evaluated by three (3) month wrapping test in the water. After three (3) months, the residue of the mat was ocularly observed and estimated according to the following scoring system:
⊚: very good ◯: good Δ: middle X: bad

The results are shown in Table 1.

### EXPERIMENTAL EXAMPLE 3

### Soil Temperature-Elevating Effect

An automatic thermometer was set up under the mat between rice seedlings. Soil temperature was recorded every hour for one (1) month. The average temperature in mulched cultivation was compared with that in non-mulched cultivation. The results are shown in Table 1.

### EXPERIMENTAL EXAMPLE 4

### Adsorption of the Mat to the Soil

Adsorption of the mat to the soil was ocularly observed after one (1) month of setting up the mat and estimated according to the following scoring system:
⊚: very good ◯: good Δ: middle X: bad

The results are shown in Table 1.

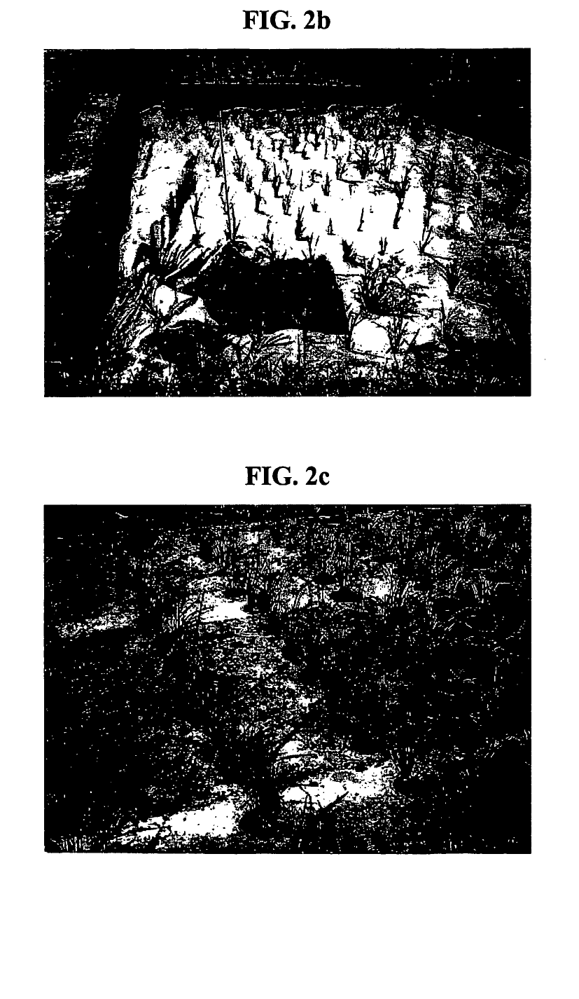

Additionally, the adsorption to the soil was compared in reference of the photographs of FIG. 2. FIG. 2a shows the seedling stand and weed growth in non-mulched cultivation; FIG. 2b shows the seedling stand and weed growth after one (1) month of seeding in rice cultivation using the mulching-mat of Comparative Example 1; and FIG. 2c shows the seedling stand and weed growth after one (1) month of seeding in rice cultivation using the mulching-mat of Example 1.

As shown in FIG. 2, the present mat has good adsorption to the soil, so as to effectively inhibit the growth of weeds, compared with that of Comparative Example 1 composed of the resin film alone without paper sheet. The mat of Comparative Example 1 has poor adsorption to the soil, not to effectively inhibit the appearance and growth of the weeds.

TABLE 1

| | Composition of the mat | | | Properties of the mat | | | |
|---|---|---|---|---|---|---|---|
| | | Thickness of | Thickness | Weed | | | |
| | | the recycled | of | control | | | |
| | | paper | the mat | value | | Soil temperature- | Adsorption |
| | Component | (μm) | (μm) | (%) | Biodegradability | elevating effect | to the soil |
| Ex. 1 | PBS-coated | 55 | 65 | 95 | ◯ | +2.4 | ◯ |
| | paper | | | | | | |
| Ex. 2 | PBS-coated | 55 | 67 | 95 | ◯ | +2.3 | ◯ |
| | paper | | | | | | |
| Ex. 3 | PBS-coated | 55 | 69 | 95 | ◯ | +2.7 | ◯ |
| | paper | | | | | | |
| Ex. 4 | PBA/Ca-coated | 55 | 65 | 92 | ⊚ | +2.1 | ◯ |
| | paper | | | | | | |
| Ex. 5 | PCL-coated | 55 | 65 | 93 | ◯ | +2.2 | ◯ |
| | paper | | | | | | |
| C. Ex. 1 | PBS film | — | 15 | 78 | ◯ | +1.3 | X |
| C. Ex. 2 | PBS film | — | 25 | 78 | ◯ | +1.6 | X |
| C. Ex. 3 | Recycled paper | 55 | 55 | 46 | ⊚ | −0.3 | ◯ |

### EXPERIMENTAL EXAMPLE 5

### Soil Moisture Capacity

Before setting up the mat, irrigation water was drained from the rice field and after seeding, artificial irrigation was not supplied for 70 days. The amount of rainfall was calculated based on the meteorological record. Soil moisture content (calculated by the following formula) in mulched cultivation was compared with that in non-mulched cultivation. The results are shown in Table 2.
Soil moisture content (%)={water weight in the soil/(soil weight−water weight in the soil)}×100

TABLE 2

| | Composition of the mat | | | Properties of the mat | | | |
|---|---|---|---|---|---|---|---|
| | | Thickness of | Thickness | Weed | | | |
| | | the recycled | of | control | | | |
| | | paper | the mat | value | | Soil temperature- | Adsorption |
| | Component | (μm) | (μm) | (%) | Biodegradability | elevating effect | to the soil |
| Ex. 1 | PBS-coated | 55 | 65 | 95 | ◯ | +2.4 | ◯ |
| | paper | | | | | | |
| Ex. 2 | PBS-coated | 55 | 67 | 95 | ◯ | +2.3 | ◯ |
| | paper | | | | | | |
| Ex. 3 | PBS-coated | 55 | 69 | 95 | ◯ | +2.7 | ◯ |
| | paper | | | | | | |
| Ex. 4 | PBA/Ca-coated | 55 | 65 | 92 | ⊚ | +2.1 | ◯ |
| | paper | | | | | | |
| Ex. 5 | PCL-coated | 55 | 65 | 93 | ◯ | +2.2 | ◯ |
| | paper | | | | | | |
| C. Ex. 1 | PBS film | — | 15 | 78 | ◯ | +1.3 | X |
| C. Ex. 2 | PBS film | — | 25 | 78 | ◯ | +1.6 | X |
| C. Ex. 3 | Recycled paper | 55 | 55 | 46 | ⊚ | −0.3 | ◯ |

### EXPERIMENTAL EXAMPLE 5

### Soil Moisture Capacity

Before setting up the mat, irrigation water was drained from the rice field and after seeding, artificial irrigation was not supplied for 70 days. The amount of rainfall was calculated based on the meteorological record. Soil moisture content (calculated by the following formula) in mulched cultivation was compared with that in non-mulched cultivation. The results are shown in Table 2.
Soil moisture content (%)={water weight in the soil/(soil weight−water weight in the soil)}×100

TABLE 2

| | | Soil moisture content (%) | |
|---|---|---|---|
| Days elapsed | Amount of | in the cultivation using the | in non-mulched |
| since seeding | rainfall (mm) | mat of Ex. 1 | cultivation |
| 0-10 days | 0.4 | 54.2 | 45.2 |
| 11-20 days | 2.8 | 53.1 | 39.5 |
| 21-30 days | 0.0 | 49.1 | 31.2 |
| 31-50 days | 154.7 | 52.9 | 54.8 |
| 51-70 days | 122.2 | 47.7 | 41.4 |

In the table 2, the amount of rainfall is the accumulation of the rainfalls during the above-identified days.

As shown in the Table 2, the present mat can increase soil moisture capacity, which saves irrigation water in rice cultivation.

Based on the results of the above experimental examples, it should be clearly understood that the present mulching-mat can be completely degraded in several months not causing environmental pollution and exhibit good mulching properties by preventing the growth of weeds, elevating soil temperature and increasing soil moisture capacity, to be advantageously applied for rice cultivation. Further, the present mat can be mass produced by means of extrusion molding and has good strength and durability.

Although preferred embodiments of the present invention have been described in detail hereinabove, it should be clearly understood that many variations and/or modifications of the basic inventive concepts herein taught which may appear to those skilled in the art will still fall within the spirit and scope of the present invention as defined in the appended claims.

1. Canceled.

2. The mulching-mat for preventing weeds comprising a laminated sheet obtained by coating paper with biodegradable resin film containing biodegradable thermoplastic aliphatic polyester, wherein said polyester is represented by the following Formula 1 or Formula 2: 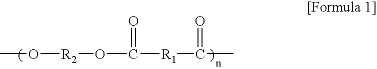
wherein, n is an integer and represents repeating unit; R₁ represents an aliphatic hydrocarbon having a carbon number of 2˜6; and R₂ represents an aliphatic hydrocarbon having a carbon number of 2˜8 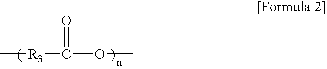
wherein, n is an integer and represents repeating unit; and R₃ represents an aliphatic hydrocarbon having a carbon number of 2˜6.

3. The mulching-mat according to claim 2, wherein said resin film further comprises one or more additive selected from a group consisting of calcium carbonate, talc and starch.

4. A method for manufacturing the mulching-mat of claim 2 comprising steps of;
(1) melt coating paper with biodegradable resin film containing biodegradable thermoplastic aliphatic polyester by means of extrusion molding; and
(2) scrolling the coated paper obtained in step (1).

5. A method for elevating soil temperature and increasing soil moisture capacity by using a biodegradable mulching-mat described in claim 2.
